(19) United States
(12) Patent Application Publication
(10) Pub. No.: US 2012/0017558 A1
(43) Pub. Date: Jan. 26, 2012

(54) SELF-UNJAMMING MOTORIZED TRIMMING APPARATUS, PARTICULARLY A HEDGE TRIMMER

(75) Inventor: Roger Pellenc, Pertuis (FR)

(73) Assignee: PELLENC (Societe Anonyme), Pertuis (FR)

(21) Appl. No.: 13/132,131

(22) PCT Filed: Nov. 23, 2009
(86) PCT No.: PCT/FR09/01337

§ 371 Date: Oct. 15, 2011

(30) Foreign Application Priority Data
Dec. 1, 2008 (FR) 08/06734

(51) Int. Cl. A01G 3/04

(52) U.S. Cl. 56/233

(57) ABSTRACT

A motorized trimming apparatus having two blades placed side-by-side, has triangularly or trapezoidally cut teeth spaced apart from each other, at least one of said blades being movable to enable the cutting by shearing of wood inserted between said teeth, and connected to a drive device. The apparatus is characterized in that it comprises a means for controlling the drive device, said control means being constructed or configured so as to detect stops in movement of the movable blade(s) and to instantaneously and automatically control the reversal of the rotational direction of said drive device and thus control the reversal of the direction of movement of said movable blade(s).

### CROSS-REFERENCE TO RELATED U.S. APPLICATIONS

Not applicable.

### STATEMENT REGARDING FEDERALLY SPONSORED RESEARCH OR DEVELOPMENT

Not applicable.

### NAMES OF PARTIES TO A JOINT RESEARCH AGREEMENT

Not applicable.

### REFERENCE TO AN APPENDIX SUBMITTED ON COMPACT DISC

Not applicable.

### BACKGROUND OF THE INVENTION

1. Field of the Invention

The present invention concerns a self-unjamming or “self-unjammable” motorized trimming apparatus.

2. Description of Related Art Including Information Disclosed Under 37 CFR 1.97 and 37 CFR 1.98

The invention is very advantageously applicable to hedge trimmers used for trimming hedges, as much for shaping them as for maintaining them. Such portable motorized tools feature a cutter bar comprising two symmetrical blades placed one on top of the other and provided with spaced triangular or trapezoidal teeth, with at least one of these blades being driven in a very rapid straight-line alternating movement for shearing off the woody material seized between the teeth of the blades of the cutter bar.

On these two blades either both are provided with cutting teeth or only one of them is so equipped.

Both blades may be mobile and each driven in an alternating straight-line movement and of reversible direction or only one of the two blades may be driven in an alternating straight-line movement.

The alternating straight-line movement of the mobile blade or blades is generated by an electric motor or a combustion engine, or even by a pneumatic or hydraulic motor the power takeoff of which is connected to one of the extremities of the mobile cutting blade or of each mobile cutting blade, by means of a reducer, one or two eccentrics and one or two connecting rods for transforming the rotary movement of the drive motor into a straight-line alternating movement of the mobile cutting blade(s).

However, the invention may be applied to other types of cutting tools or machines, such as for example the cutting tools described in documents EP-0147344 and FR-2730378, comprising circular cutting devices lying upon another provided with peripheral teeth and of which at least one is driven in rotation by a motor, said cutting devices being fitted in complementary fashion and structurally similar to constitute a system of cutting blades and counter-blades producing a shearing cut.

A significant drawback of the current motorized cutting tools, in particular of hedge-trimmers with a cutter bar of the aforementioned type, resides in the fact that since their drive motor turns only in one direction and when a piece of wood that is either too thick or too hard enters into the space between the teeth of the cutting blades and cannot be cut due to a lack of power, the eccentric is unable to reach its highest point which would allow the inversion of the direction of movement of the cutting blades, the device jams and stops. It is then impossible to unjam it without removing the wood stuck between the teeth of the cutting blades by pulling hard on it, while running thereby the risk of mechanical deterioration of the devices and of causing injury to the users. Furthermore, such blockages causing the devices to stop working at an inconvenient moment, are very stressful for the operators.

The invention proposes providing the users with motorized cutting tools, and in particular hedge trimmers that operate without the aforementioned drawbacks.

### BRIEF SUMMARY OF THE INVENTION

According to the invention this objective has been achieved by virtue of a trimming device featuring two blades lying upon another and equipped with spaced teeth, at least one of these blades being mobile and connected to a motorization device which allows to impart to it a movement in two directions opposite to each other, so as to allow the shearing off of wood located between said teeth. The trimming apparatus being remarkable especially in that it features a means of piloting the motorization device, this piloting means being fitted or configured to detect any stopping of movement of the mobile blade or blades due to a blockage of it or them while in operation, and to command instantly and automatically the reversal of the sense of rotation of said motorization device and hence the reversal of the direction of movement of said mobile blade(s) and the spreading of the teeth of the blades lying upon another.

In case of a blockage this reversal allows the cutting parts of the teeth of the blades to separate themselves from the jammed wood by moving apart from each other under the action of the eccentric(s) up to reaching their highest point thereby allowing the reversal of the sense of movement of the cutting blades, then to come back again towards each other. In this case, the wood is either completely chopped up and the work continues normally, or a new blockage occurs. Then the sense of rotation of the motorization device is again reversed automatically and this until the persistent blockage has completely disappeared and work resumes normally, without the user being aware that a blockage problem existed.

The invention does away with annoying stops caused by the presence of wood that is too hard or of too large diameter to be cut between the teeth of the cutting system.

It also eliminates the risks of mechanical deterioration of the trimming apparatus and of injury to the operators, when, during their work they encounter wood that is too thick and/or too hard to be cut and which needs to be freed from the teeth of the cutting system by pulling hard on the wood.

Advantageously the invention is applicable as previously indicated, to motorized portable hedge trimmers of the type featuring a cutter bar comprising two symmetrical blades lying upon another and equipped with spaced triangular or trapezoidal teeth, one at least of these cutting blades being mobile and capable of being put in alternating straight-line motion allowing the shearing cut of wood finding itself between the teeth of the blades of the cutter bar.

It is to be noted that regardless of whether the sense of rotation of the motor is clockwise or counterclockwise, the relative alternating movement between the blades transmitted through the eccentric(s) remains the same.

According to a preferred method of execution the motorization device of this hedge-trimmer comprises a brushless electric motor with electronic controls, known as such, and the means of piloting of this motor consists of an electronic card that is also configured to detect on the one hand the stoppages of rotation of the motor, due to the immobilization of the mobile blade(s), and on the other hand to command the reversal of the sense of rotation of said motor. It is clear that when the blade/counterblade system is jammed in a piece of wood that is too big and/or too hard to be cut during the first approach movement of the teeth between which this wood is jammed, the eccentrics actuating said blade(s) are no longer able to turn, thus preventing the rotation of the motor.

The electronic card managing the control of the motor detects that the motor no longer responds to the rotation command (zero rotation and/or overcurrent) and deduces therefrom that the blade and counter-blade are jammed, so this same card then commands the motor immediately and automatically to change its sense of rotation.

The reversal of the sense of rotation has the effect of allowing the eccentrics to rotate which provokes the teeth of the blade to move away from the teeth of the counter-blade, thus freeing them from the wood into which they are wedged.

Under the effect of the eccentrics the teeth of the blades and counter-blades then come together again and are going to try again to cut the wood: if the wood was almost cut the fact of returning with a maximum speed generating a certain inertia can allow the blade and the counter-blade to cut the wood and the tool continues to work normally; if the wood is not cut during the return, there is again a jam and the procedure described above is implemented once more; if after a determinate number of unsuccessful unjamming attempts (ten for example) the wood is still not cut, then, for safety reasons, the electronic motor management control card will command the motor to stop.

### BRIEF DESCRIPTION OF THE DRAWINGS

The aims, characteristics and advantages cited above, and still more will become evident from the following description and the attached drawings in which:

FIG. 1 is a perspective view of an example of production of a trimming apparatus in application of the invention and which, according to this example, is constituted by a hedge trimmer.

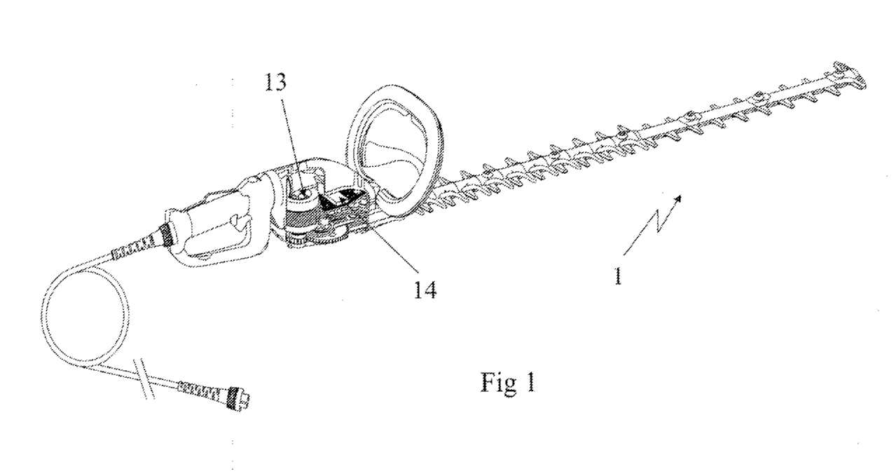

FIG. 2 is a plan view of the cutter bar of this apparatus and of the mechanism providing the alternating straight-line and reverse movement of the two mobile cutting blades of said cutter bar, said cutting blades being shown in one of their extreme positions.

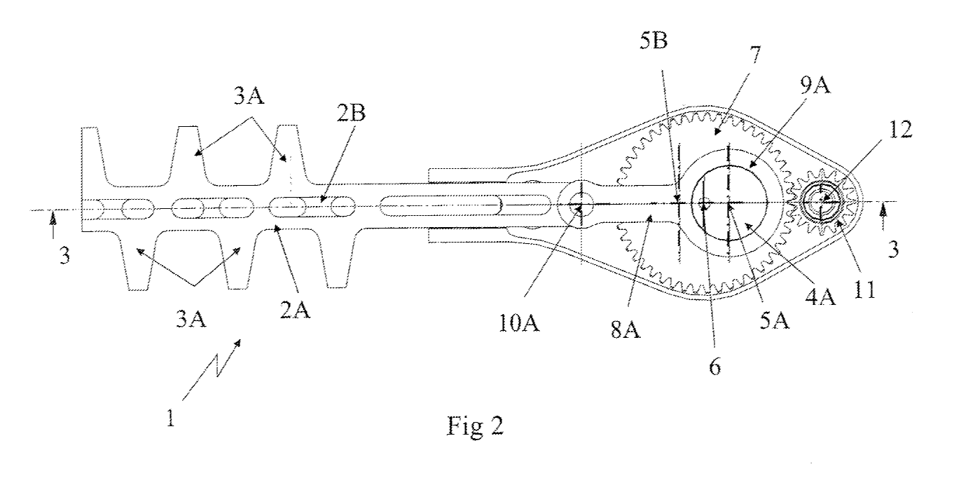

FIG. 3 is a larger scale section view along line 3-3 of FIG. 2.

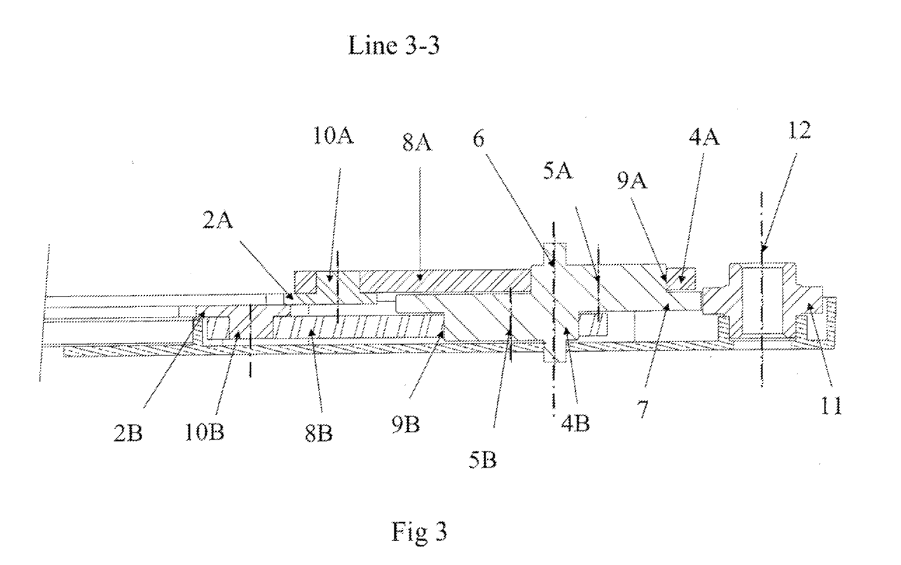

FIG. 4 is a plan view similar to FIG. 2 showing the cutting blades in one of their two intermediate positions.

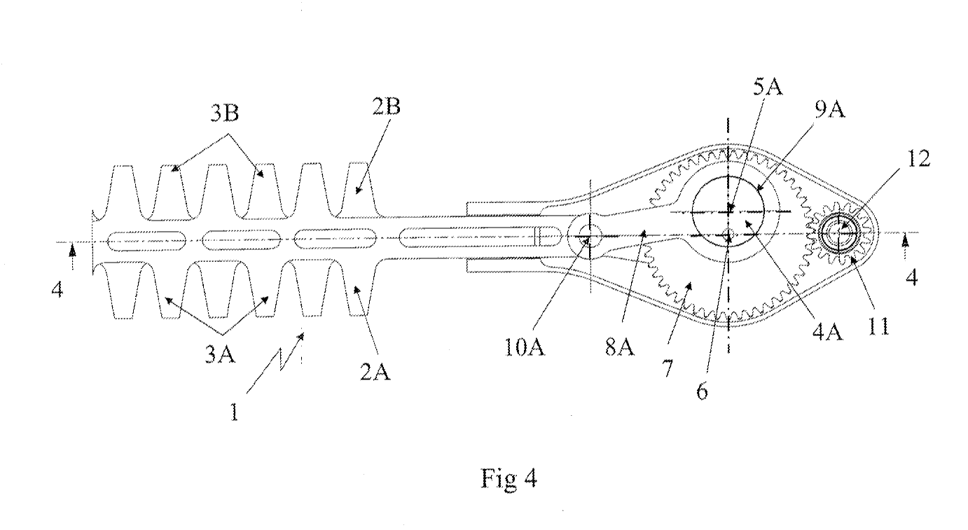

FIG. 5 is a plan view similar to FIG. 2 showing the cutting blades in their second extreme position.

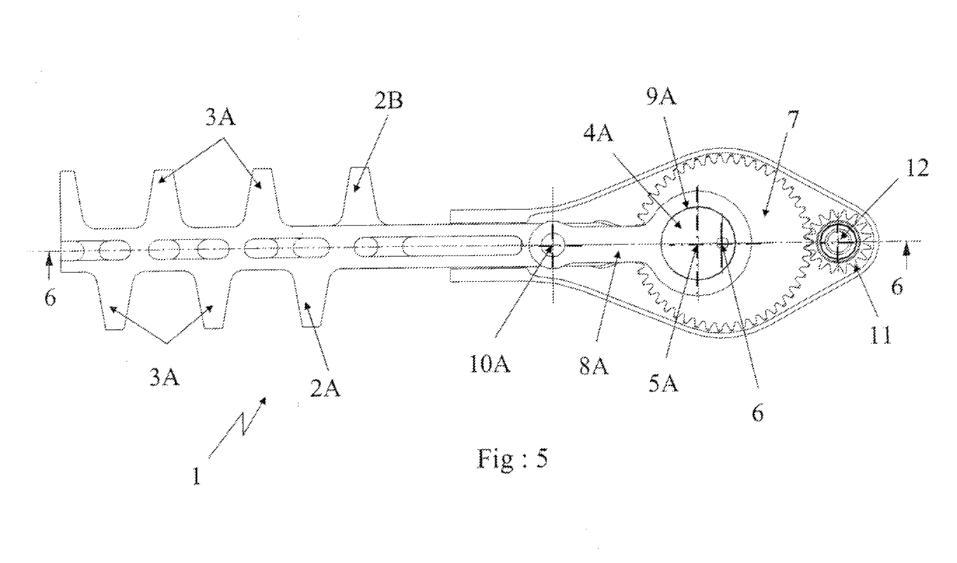

FIG. 6 is a larger scale section view according to line 6-6 of FIG. 5.

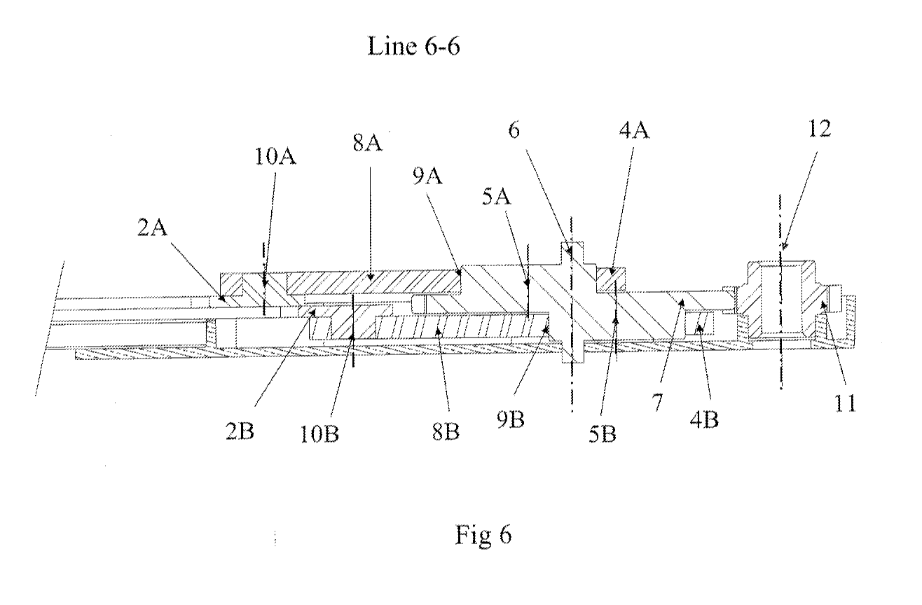

FIG. 7 is a plan view similar to FIG. 4 showing the drive mechanism of the cutting blades in a position corresponding to the second intermediate position of the blades.

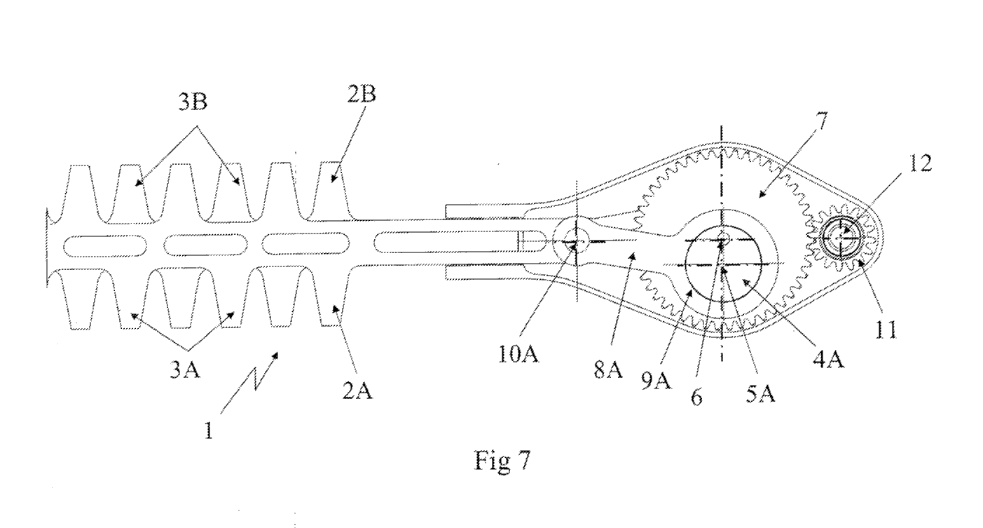

FIG. 8 is a plan view of an example of production of a circular cutting tool to which the invention can be applied as well.

Reference to said drawings is being made to describe interesting although by no means limiting examples of production of the self-unjamming or “self-unjammable” trimming apparatus according to the invention.

### DETAILED DESCRIPTION OF THE INVENTION

Subsequently in this presentation and in the claims the neologism “self-unjammable” will be used, which means that which unwedges or unjams itself automatically, without intervention by the user, instead of the term “self-unjamming”.

On the other hand, the term trimming apparatus designates motorized portable trimming devices, such as hedge trimmers, lawn trimmers etc., as well as cutting tools intended for equipping automated trimming machines such as, for example pre-trimming machines, pruning machines etc.

The hedge trimmer shown as an example features a cutter bar 1 comprising essentially of two symmetrical blades lying upon another 2A, 2B, the longitudinal opposing edges of which are equipped with spaced cutting teeth, respectively 3A, 3B, of triangular or trapezoidal shape and with uniform spacing. At least one of these blades 2A, 2B is mobile and can be animated with an alternating straight-line movement which allows the cut by shearing of the wood finding itself between the teeth 3A, 3B of said blades, during the work.

According to the example shown, the two blades 2A, 2B are mobile and each animated by an alternating straight-line and reverse movement, during the operation of the apparatus.

Preferably the teeth 3A, 3B of the two blades 2A, 2B are provided with opposing cutting edges, but it would be possible that only one of the two cutting blades be equipped with opposing cutting edges, the other blade being shaped so as to serve as counter-blade to enable a cut by shearing.

In the following account the blades 2A, 2B (or 15A, 15B) are both indiscriminately called “cutting blades” whether they be two cutting blades or only one cutting blade and a counter-blade, these two blades working together to produce a cutting action by shearing.

The alternating straight-line movement of the blades 2A, 2B is generated by a dual eccentric system and two connecting rods put into rotation by a motor and a reducer.

This system comprises two eccentrics 4A, 4B integrated into a toothed wheel 7 and located on its opposing faces. Said eccentrics being arranged so that their own axes 5A, 5B are positioned symmetrically relative to the rotary axis 6 of the toothed wheel 7.

The rod 8A, 8B connected in rotation on the one end by means of the articulation 9A, 9B to each eccentric 4A, 4B, and on the other end by means of an articulation 10A, 10B, to the proximal extremity of the corresponding cutting blade 2A or 2B, said cutting blades being guided in translational motion and being kept applied against each other by means known as such.

The toothed wheel 7 meshes with a drive sprocket 11 mounted fast on the driven shaft 12 of the motorization device of the apparatus to create the reducer.

This device may comprise an electric motor, a thermal engine, or a pneumatic or hydraulic motor.

Preferably this motor 13 is an electric motor of the brushless type with electronic controls.

According to an important characteristic arrangement of the invention, the apparatus features a piloting means for the motorization device 13, and this piloting means is fitted or configured not only to detect the stoppages of the movement of the mobile blade(s) 2A, 2B while working, but also to command instantly and automatically the reversal of the sense of rotation of said device and thereby the reversal of movement of said mobile blade(s).

Very advantageously this piloting means includes an electronic card 14, for example housed in a compartment in the housing of motor 13 or in the battery pack supplying said motor with DC power.

This electronic card is also configured not only to detect the stoppages of the movement of the mobile blade(s) 2A, 2B while working, but also to command instantly and automatically the reversal of the sense of rotation of the brushless electric motor 13 or other motorization device and thereby the reversal of movement of said mobile blade(s).

The motorization device may include an electric motor other than a brushless electric motor

(DC motor or AC brush motor), or a pneumatic or hydraulic motor, or a thermal engine. In this case, an electric or electronic detection device will be added to the piloting means of the motor or motorization device, which makes it possible to detect whether the mobile blade(s) are stuck, this detection device may consist of a force and/or displacement detector known as such, like for instance a strain gauge, optical detector etc., connected to the electronic card controlling the motor or the motorization device.

In case of a blockage and considering an apparatus driven by a pneumatic or hydraulic motor, the detector will command the electronic piloting card to change the sense of rotation of said motor by acting on the solenoid control valves in order to reverse the power supply to the motor.

In the case of apparatus driven by a thermal engine, one adds,—after the clutch, on the input axis of the reducer driving the eccentric(s) activating the mobile blade(s)—a set of gears or reversing system known as such, which allows changing the sense of rotation of said reducer, this set of gears or reversing system being controlled electrically according to the commands received from the sensor which detects any stoppage of the cutter bar.

It is easy to understand that the invention can be applied to apparatus or machines other than those featuring cutting blades with an alternating straight-line movement.

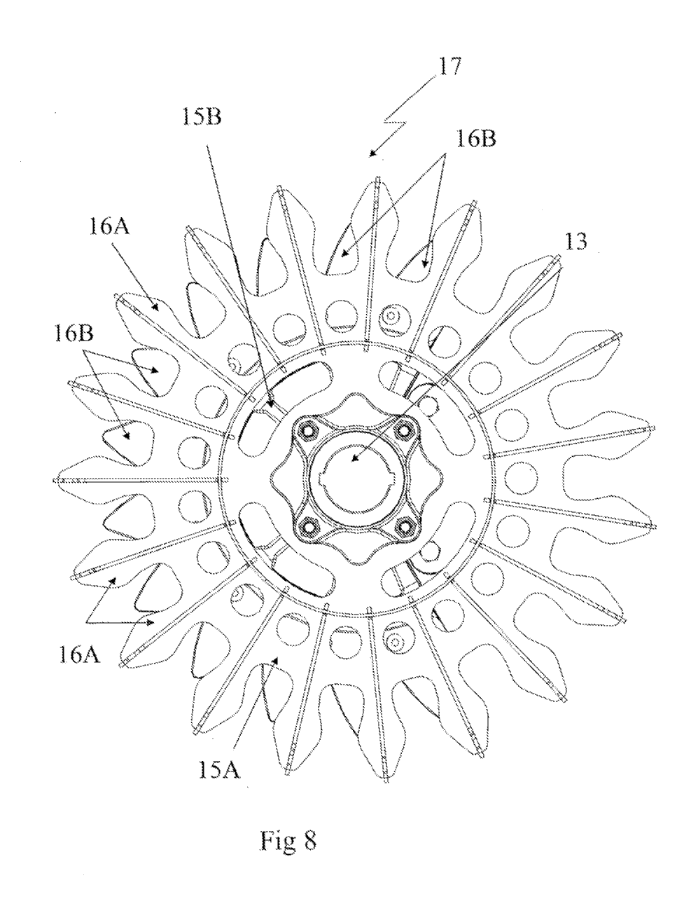

For instance, the invention is applicable to circular cutting tools of the kind described in the documents EP-0147344 and FR-2730378. Such tools, an example of which is shown in FIG. 8, comprising circular cutting elements lying upon another 15A, 15B, equipped with peripheral teeth 16A, 16B, respectively, and of which one 16A at least is driven in rotation by a motor, said cutting elements being fitted in a complementary manner and structurally similar so as to constitute a system of cutting blades and counter-blades producing a shearing cut.

1. Motorized trimming apparatus, of the kind featuring two blades lying upon another and equipped with spaced triangular or trapezoidal cutting teeth, one of these blades at least being mobile and connected to a motorization device which makes it possible to communicate to it a movement in two directions of opposite sense, so as to enable the shearing cut of wood finding itself between said teeth, characterized in that it features a means of piloting the motorization device, this means of piloting being fitted or configured to detect the stoppage of the movement of the mobile blade(s) due to a blockage of the latter, during operation and to command instantly and automatically the reversal of the sense of rotation of said motorization device and thus the reversal of the sense of movement of said mobile blade(s) and the gap between the teeth of the blades lying upon another.

2. Motorized self-unjammable trimming apparatus, according to claim 1, characterized in that the means of piloting the motorization device includes an electronic card which is configured to command instantly and automatically the reversal of the sense of rotation of said device.

3. Motorized self-unjammable trimming apparatus, according to claim 2, characterized in that the motorization device is constituted by an electric brushless motor with electronic controls, and in that the electronic card for the control of this motor is configured to detect the stoppages of the movement of the mobile blade(s) of said apparatus while it is in operation.

4. Motorized self-unjammable trimming apparatus, according to claim 2, characterized in that the motorization device is constituted by an electric DC brush motor, or by an AC brush motor, or by a pneumatic or a hydraulic motor, and in that the means of piloting for said device includes also a detection device capable of sensing when the mobile blade(s) are blocked and of sending this information to the electronic card.

5. Motorized self-unjammable trimming apparatus, according to claim 4, characterized in that said detection device consists of comprises a force and/or displacement detector known as such, like, for example, a strain gauge or an optical sensor, connected to the electronic motor piloting card.

6. Motorized self-unjammable trimming apparatus, according to claim 2, characterized in that the electronic card for piloting the motorization device is configured to command the stop of the latter, after a determinate number of unsuccessful attempts of unjamming.

7. Motorized self-unjammable trimming apparatus, according to claim 1, characterized in that it comprises a hedge trimmer of the kind that features a cutter bar comprising two symmetrical blades lying upon another and equipped with spaced triangular or trapezoidal cutting teeth, one at least of these blades being connected to the motorization device for communicating to it an alternating straight-line movement.

8. Motorized self-unjammable trimming apparatus, according to claim 7, characterized in that the two symmetrical blades lying upon another and equipped with spaced triangular or trapezoidal cutting teeth of the cutter bar are mobile and connected to the motorization device for communicating to them an alternating straight-line and reversible movement.

9. Motorized self-unjammable trimming apparatus, according to claim 1, characterized in that it is made in the form of a circular trimming tool comprising circular cutting elements lying upon another equipped with peripheral teeth and of which one at least is driven in rotation by the motorization device.
